(19) United States
(12) Patent Application Publication
(10) Pub. No.: US 2004/0128236 A1
(43) Pub. Date: Jul. 1, 2004

(54) Methods and apparatus for evaluating and using profitability of a credit card account

(76) Inventors: Ron T. Brown, Allen, TX (US); Rawy R. Shediac, Westport, CT (US); Robert E. Muckle, Wolcott, CT (US); Sue E. Harber, Charlotte, NC (US); Suneetha J. Malkani, Poughkeepsie, NY (US); Edward V. Viscount, Smithtown, NY (US); Jill F. Chamberlain, Tucson, AZ (US); Kamal Gupta, Chandigarh (IN)

Correspondence Address: BUCKLEY, MASCHOFF, TALWALKAR LLC, 5 ELM STREET, NEW CANAAN, CT, 06840, US

(21) Appl. No.: 10/334,454

(22) Filed: Dec. 30, 2002

(51) Int. Cl. G06F 17/60

(52) U.S. Cl. 705/39; 705/35

(57) ABSTRACT

A system, method, apparatus, means, and computer program code for evaluating one or more credit card accounts and, more particularly, for determining the profitability of one or more credit card accounts. According to embodiments of the present invention, data associated with one or more variables is determined for one or more credit card accounts. Once the data is collected or otherwise determined for a credit card account, it can be used to compute profitability of the credit card account. An account's profitability may then be used to determine a course of action regarding the credit card account.

### FIELD OF THE INVENTION

The present invention relates to a method and apparatus for evaluating one or more credit card accounts and, more particularly, evaluating profitability of one or more credit card accounts and using the profitability to make a decision regarding one or more credit card accounts.

### BACKGROUND OF THE INVENTION

Private label, co-brand, and other credit card issuers often create portfolios of credit card accounts. For example, a credit card issuer may enter into a relationship with a department store in which the credit card issuer may provide private label credit cards in the name of the department store to customers of the department store. The credit card issuer may then manage and service the issued credit cards on behalf of the department store. In some circumstances, some credit card accounts associated with the department store may be more profitable than other credit card accounts. The department store may wish to make a decision regarding a credit card account based on the account's contribution to the profitability of the credit card portfolio associated with the department store. In addition, the department store may want to make one or more decisions regarding a portfolio of credit card accounts based on the profitability of one or more credit card accounts in the portfolio.

It would be advantageous to provide a method and apparatus for evaluating the profitability of one or more credit card accounts, particularly where the one or more credit card accounts are part of a portfolio of credit card accounts. In addition, it would be advantageous to provide a method and apparatus for allowing a way of using profitability of credit card accounts to differentiate service, benefits, promotions, etc. provided to holders of the credit card accounts.

### SUMMARY OF THE INVENTION

Embodiments of the present invention provide a system, method, apparatus, means, and computer program code for evaluating credit card accounts as well as determining the profitability of one or more credit card accounts. In some embodiments, the profitability of one or more credit card accounts may be a factor in one or more decisions made regarding the one or more of the credit card accounts and/or a portfolio that includes the one or more credit card accounts.

According to embodiments of the present invention, data associated with one or more variables is determined for one or more credit card accounts. In some embodiments, the data may come from users or holders of the credit card accounts, merchants or other providers that issue the credit cards and/or collect data on use of the credit card accounts, credit agencies, government agencies. In some embodiments, data regarding one or more credit card accounts may be stored in, or retrieved from, one or more databases, Web sites, or other resource. Once the data is collected or otherwise determined for a credit card account, the data can be used to compute profitability of the credit card account(s) by determining a net income and an average investment for the credit card account.

In some embodiments, after a profitability for one or more credit card accounts is determined, the profitability information may be provided in a communication (e.g., email message, instant message communication, facsimile transmission, voicemail message, FTP or XML transmission, etc.) to one or more designated parties, software applications, devices, databases, etc. In addition, or as an alternative, the profitability information may be used as part of a decision making or course of action selection process regarding one or more credit card accounts and/or a portfolio or other group of credit card accounts.

Additional objects, advantages, and novel features of the invention shall be set forth in part in the description that follows, and in part will become apparent to those skilled in the art upon examination of the following or may be learned by the practice of the invention. According to some embodiments of the present invention, a method formaking use of a profitability of a credit card account may include determining data for a plurality of variables associated with a credit card account; determining a score associated with the account based, at least in part, on the data for a plurality of variables, wherein the score is indicative of a profitability of the credit card account; and determining a course of action regarding the credit card account based, at least in part, on the score. In some other embodiments, a method for making a determination regarding a credit card account may include determining data for a plurality of variables associated with each account in a plurality of credit card accounts; determining a score associated with each account in the plurality of credit card accounts based, at least in part, on the data for a plurality of variables associated with the account, wherein a score for an account is indicative of a profitability of the account; and determining a course of action for an account in the plurality of credit card accounts based, at least in part, on the account's associated score. In some further embodiments, a method for making a determination regarding at least one credit card account may include determining a plurality of credit card accounts; determining data for a plurality of variables associated with each credit card account in the plurality of credit card accounts; determining a score associated with each credit card account in the plurality of credit card accounts based, at least in part, on the data for a plurality of variables associated with the account, wherein a score for a credit card account is indicative of a profitability of the credit card account; and determining a course of action for at least one of the accounts in the plurality of credit card accounts based, at least in part, on at least two scores associated with credit card accounts in the plurality of credit card accounts. In some additional embodiments, a method for determining profitability of a credit card account in a portfolio of credit card accounts may include selecting a credit card account from a portfolio of credit card accounts; determining a gross income associated with the credit card account for a designated time period; determining an average net investment associated with the credit card account for the designated time period; and computing a score for the credit card account based on the gross income and the net investment, the score being indicative of profitability for the credit card account.

According to some embodiments of the present invention, a system for making a determination regarding a credit card account may include a memory; a communication port; and a processor connected to the memory and the communication port, the processor being operative to determine data for a plurality of variables associated with a credit card account; determine a score associated with the account based, at least in part, on the data for a plurality of variables, wherein the score is indicative of a profitability of the credit card account; and determine a course of action regarding the credit card account based, at least in part, on the score. In some other embodiments, a system for making a determination regarding a credit card account may include a memory; a communication port; and a processor connected to the memory and the communication port, the processor being operative to determine data for a plurality of variables associated with each account in a plurality of credit card accounts; determine a score associated with each account in the plurality of credit card accounts based, at least in part, on the data for a plurality of variables associated with the account, wherein a score for an account is indicative of a profitability of the account; and determine a course of action for an account in the plurality of credit card accounts based, at least in part, on the account's associated score. In some additional embodiments, a system for making a determination regarding of at least one credit card account may include a memory; a communication port; and a processor connected to the memory and the communication port, the processor being operative to determine a plurality of credit card accounts; determine data for a plurality of variables associated with each credit card account in the plurality of credit card accounts; determine a score associated with each credit card account in the plurality of credit card accounts based, at least in part, on the data for a plurality of variables associated with the account, wherein a score for a credit card account is indicative of a profitability of the credit card account; and determine a course of action for at least one of the accounts in the plurality of credit card accounts based, at least in part, on at least two scores associated with credit card accounts in the plurality of credit card accounts. In some further embodiments, a system for determining profitability of a credit card account may include a memory; a communication port; and a processor connected to the memory and the communication port, the processor being operative to select a credit card account from a portfolio of credit card accounts; determine a gross income associated with the credit card account for a designated time period; determine an average net investment associated with the credit card account for the designated time period; and determine a score for the credit card account based on the gross income and the net investment, the score being indicative of profitability for the credit card account.

According to some embodiments of the present invention, a computer program product in a computer readable medium for making a determination regarding a credit card account may include first instructions for obtaining data for a plurality of variables associated with a credit card account; second instructions for calculating a score associated with the account based, at least in part, on the data for a plurality of variables, wherein the score is indicative of a profitability of the credit card account; and third instructions for identifying a course of action regarding the credit card account based, at least in part, on the score. In some other embodiments a computer program product in a computer readable medium for making a determination regarding a credit card account may include first instructions for obtaining data for a plurality of variables associated with each account in a plurality of credit card accounts; second instructions for calculating a score associated with each account in the plurality of credit card accounts based, at least in part, on the data for a plurality of variables associated with the account, wherein a score for an account is indicative of a profitability of the account; and third instructions for identifying a course of action for an account in the plurality of credit card accounts based, at least in part, on the account's associated score. In some additional embodiments, a computer program product in a computer readable medium for making a determination regarding at least one credit card account may include first instructions for identifying a plurality of credit card accounts; second instructions for obtaining data for a plurality of variables associated with each credit card account in the plurality of credit card accounts; third instructions for calculating a score associated with each credit card account in the plurality of credit card accounts based, at least in part, on the data for a plurality of variables associated with the account, wherein a score for a credit card account is indicative of a profitability of the credit card account; and fourth instructions for identifying a course of action for at least one of the accounts in the plurality of credit card accounts based, at least in part, on at least two scores associated with credit card accounts in the plurality of credit card accounts. In some further embodiments, a computer program product in a computer readable medium for determining profitability of a credit card account may include first instructions for identifying a credit card account from a portfolio of credit card accounts; second instructions for identifying a gross income associated with the credit card account for a designated time period; third instructions for identifying an average net investment associated with the credit card account for the designated time period; and fourth instructions for calculating a score for the credit card account based on the gross income and the net investment, the score being indicative of profitability for the credit card account.

According to some embodiments of the present invention, an apparatus for making a determination regarding a credit card account may include means for obtaining data for a plurality of variables associated with a credit card account; means for calculating a score associated with the account based, at least in part, on the data for a plurality of variables, wherein the score is indicative of a profitability of the credit card account; and means for identifying a course of action regarding the credit card account based, at least in part, on the score. In some other embodiments an apparatus for making a determination regarding a credit card account may include means for obtaining data for a plurality of variables associated with each account in a plurality of credit card accounts; means for calculating a score associated with each account in the plurality of credit card accounts based, at least in part, on the data for a plurality of variables associated with the account, wherein a score for an account is indicative of a profitability of the account; and means for identifying a course of action for an account in the plurality of credit card accounts based, at least in part, on the account's associated score. In some additional embodiments, an apparatus in a computer readable medium for making a determination regarding at least one credit card account may include means for identifying a plurality of credit card accounts; means for obtaining data for a plurality of variables associated with each credit card account in the plurality of credit card accounts; means for calculating a score associated with each credit card account in the plurality of credit card accounts based, at least in part, on the data for a plurality of variables associated with the account, wherein a score for a credit card account is indicative of a profitability of the credit card account; and means for identifying a course of action for at least one of the accounts in the plurality of credit card accounts based, at least in part, on at least two scores associated with credit card accounts in the plurality of credit card accounts. In some further embodiments, an apparatus for determining profitability of a credit card account may include means for identifying a credit card account from a portfolio of credit card accounts; means for identifying a gross income associated with the credit card account for a designated time period; means for identifying an average net investment associated with the credit card account for the designated time period; and means for calculating a score for the credit card account based on the gross income and the net investment, the score being indicative of profitability for the credit card account.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a block diagram of components used in some embodiments of the present invention;

FIG. 2 is a flowchart of a first embodiment of a method in accordance with the present invention;

FIG. 3 is a flowchart of a second embodiment of a method in accordance with the present invention;

FIG. 4 is a flowchart of a third embodiment of a method in accordance with the present invention;

FIG. 5 is a block diagram of potential components that may be used in some embodiments of the server of FIG. 1;

FIG. 6 is an illustration of one potential embodiment of the account information database of FIG. 5;

FIG. 7 is an illustration of one potential embodiment of the user information database of FIG. 5; and

FIG. 8 is an illustration of one potential embodiment of the portfolio information database of FIG. 5.

### DETAILED DESCRIPTION

Applicants have recognized that there is a market opportunity for systems, means, computer software, and methods that facilitate evaluation or determination of profitability of one or more credit card accounts. In some embodiments, the profitability of one or more credit card accounts may be a factor in decisions made regarding the one or more credit card accounts. For example, a merchant may provide higher or more customized levels of customer service to people associated with the most profitable credit card accounts. As another example, a merchant may provide different promotions or marketing materials to different credit card accounts based on the profitability of each of the different credit card accounts and/or a portfolio that includes the one or more credit card accounts.

According to embodiments of the present invention, data associated with one or more variables is determined for one or more credit card accounts. In some embodiments, the data may come from users or holders of the credit card accounts, merchants or other providers that issue the credit cards and/or collect data on use of the credit card accounts, credit agencies, government agencies. In some embodiments, data regarding one or more credit card accounts may be stored in, or retrieved from, one or more databases, Web sites, or other resources. Once the data is collected or otherwise determined for a credit card account, it can be used to compute profitability of the credit card account. These and other features will be discussed in further detail below.

System

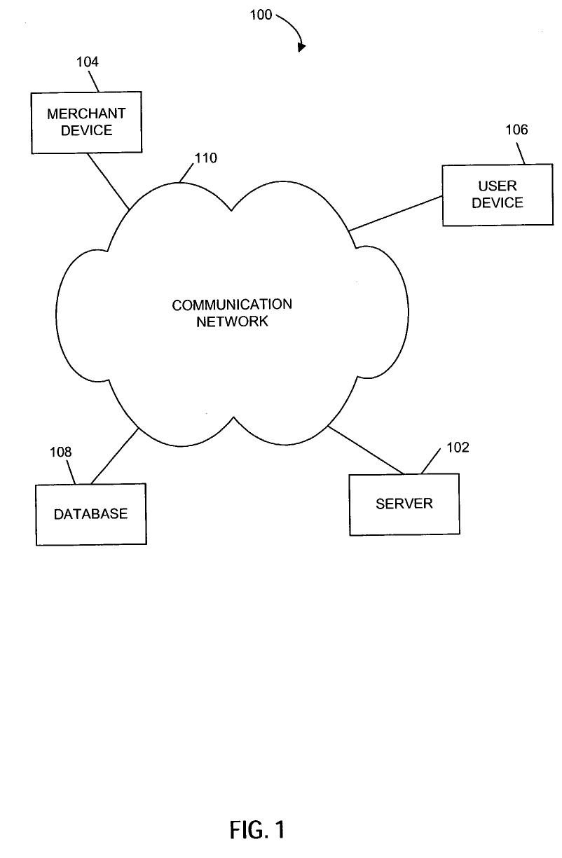

Now referring to FIG. 1, a representative apparatus or system 100 usable with the methods disclosed herein is illustrated. The apparatus 100 may include a server 102 that may communicate directly or indirectly with one or more merchant devices 104, user devices 106, databases or other resources 108 via a computer, data, or communications network 110. In some embodiments, the database 108 may be connected to the server 102, connected to or part of a database server, or communicate with the communication network 110 via another device. For purposes of further explanation and elaboration of the methods disclosed herein, in some embodiments the methods disclosed herein will be assumed to be operating on, or under the control of, the server 102.

In some embodiments, the server 102 can comprise a single device or computer, a networked set or group of devices or computers, a mainframe computer or computer system, a workstation, etc. In some embodiments, the server 102 also may function as a database server or provide other functions (e.g., Web site hosting). The use, configuration and operation of the server 102 will be discussed in more detail below.

In some embodiments, the merchant device 104 can comprise a single device or computer, a networked set or group of devices or computers, a workstation, etc. In some embodiments, the merchant device 104 also may function as a database server or provide other functions. The merchant device 104 may connected directly or indirectly to the server 102 and/or or to other devices or networks. The merchant device 104 may provide information regarding credit card applications, credit card account use, credit card holders, etc. to the server 102, some or all of which may be used to determine or evaluate profitability of one or more credit card accounts.

In some embodiments, the user or client device 106 may allow a user to interact with the server 102, the merchant device 104, and/or other devices or networks. The user devices 106 also may enable a user to access Web sites, software, databases, etc. hosted or operated by the server 102. If desired, the user device 106 also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

The database or other resource 108 may store information regarding accounts, account holders, portfolios, transactions, etc. and might not be used in some embodiments of the present invention.

Many different types of implementations or hardware configurations can be used in the system 100 and with the methods disclosed herein and the methods disclosed herein are not limited to any specific hardware configuration for the system 100 or any of its components.

The communications network 110 might be or include the Internet, the World Wide Web, or some other public or private computer, cable, telephone, client/server, peer-to-peer, or communications network or intranet. The communications network 110 illustrated in FIG. 1 is meant only to be generally representative of cable, computer, telephone, peer-to-peer or other communication networks for purposes of elaboration and explanation of the present invention and other devices, networks, etc. may be connected to the communications network 110 without departing from the scope of the present invention. In some embodiments, the communications network 110 may include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. Moreover, as used herein, communications include those enabled by wired or wireless technology.

The devices shown in FIG. 1 need not be in constant communication. For example, the merchant device 104 may communicate with the server 102 only when such communication is appropriate or necessary.

Process Description

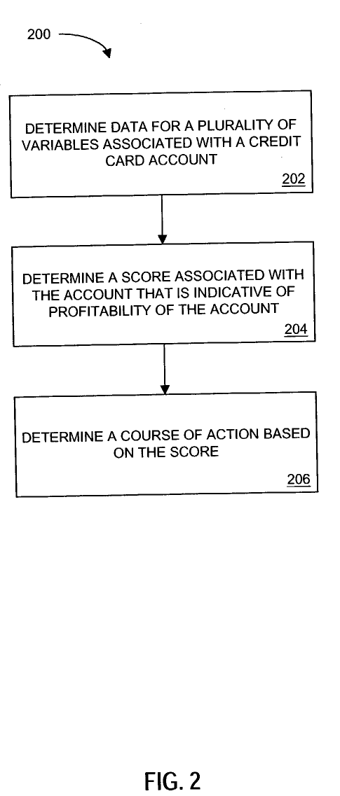

Reference is now made to FIG. 2, where a flow chart 200 is shown which represents the operation of a first embodiment of the present invention. The particular arrangement of elements in the flow chart 200 is not meant to imply a fixed order to the steps; embodiments of the present invention can be practiced in any order that is practicable. In some embodiments, some or all of the steps of the method 200 may be performed or completed by the server 102 and/or another device.

Processing begins at a step 202 during which data is determined with regard to at least one credit card account for a plurality of variables. In some embodiments, some or all of the data may be received from a merchant device and/or a user device, retrieved from a database or other resource, etc.

There may be many different types of variables or components for which data regarding an account is determined during the step 202. For example, in some embodiments, data regarding a credit card account may be determined regarding one or more of the following: the amount of purchases made using the credit card during a designated time period, the amount of returns associated with an account, the amount of promotional sales made using the credit card during a designated time period, the current balance for the credit card, the finance charge or interest rate associated with the credit card, any late payment or finance charges that have been waived for the account, income associated with the account from cross-selling, insurance premiums received that are associated with the account, interest expenses associated with the account, roll rate percentages associated with the account, acquisition costs associated with the account, customer relationship management costs associated with the account, call center costs associated with the account, collection costs associated with the account, manufacturing costs associated with the account, enabling costs associated with the account, taxes or tax rates associated with the account, etc. These variables will be discussed in more detail below. In some embodiments, information regarding one or more credit card accounts may be stored in, or retrieved from, an account information database.

During a step 204, a score is determined based on the data determined during the step 202. The score may be indicative of profitability of the account. In some embodiments, the score may be numerical, alphanumerical, color based (e.g., gold, silver, bronze), level based (e.g., high, medium, or low), rank based (e.g., first, second, third, . . . ), etc. In some embodiments, the score may be representative of a classification, ranking, categorizing, positioning, ordering, evaluating, etc. of one or more accounts based on profitability as determined using some or all of the information determined during the step 202.

As one example of how a scoring or classification of a credit card account may be determined, an evaluation may be made of profitability over a designated time period for a credit card account associated with a particular user and a particular merchant. The credit card account may be one of many private label or other credit or charge card accounts associated with the merchant. In some embodiments, evaluation of profitability of a credit card account may be based, at least in part, on the income and costs associated with the credit card account during the designated time period.

In order to determine the income associated with a credit card account during the designated time period, many different variables may be taken into account. Data or other information regarding the variables may be determined during the step 202.

First, a net credit sales amount for a credit card account may be determined for the time period which may be equal to the amount of the purchases made during the time period plus the amount of returns made for the same time period (which will be a negative value). For example, if a person made one thousand dollars worth of purchases using a credit card during a month and returned one hundred and fifty dollars worth of purchased merchandise, the net credit sales for the account for the month would be eight hundred and fifty dollars (e.g., $850=$1,000−$150).

Second, a net promotional sales amount for the credit card during the designated time period may be determined. A promotional sale may be or include special offers made by a merchant to customers. For example, the merchant may allow a customer to skip a payment, obtain a zero percent or other low percentage financing arrangement, etc. Transaction information sent from the merchant to a credit card issuer or other party may include a code or other identifier that indicates that the sale is a promotional sale.

A net promotional sales amount for a credit card account for a time period is the net sum of promotional sales for the period and may be calculated by totaling the promotional sales for an account and then subtracting promotional returns for the same period of time. For example, $500 in promotional sales for the month less $100 in promotional sales returns equals $400 in net promotional sales. In some implementations, a net promotional sales amount for a credit card account during a designated time period may be equal to zero.

Third, an insurance premium portion amount may be determined for the credit card account during the designated time period. An insurance premium portion amount for a credit card account may be equal to or based on an amount the cardholder pays for insurance to cover payoff of the remaining balance. In some cases, card balance insurance may be equal to a percentage of the current outstanding balance or may be a fixed amount charged to the credit card account per month. Often, such balance insurance is offered as part of the original agreement between a card issuer and a customer applying for a card. Thus, the insurance is an extra service provided by the card issuer for a service charge billed to the account. In some embodiments, the insurance premium portion amount for a credit card account may be equal to zero.

In some embodiments, the insurance premium portion is the portion of the insurance premium which is profit to the card issuer or service provider and may be calculated by multiplying an insurance premium yield associated with the account times an insurance yield percentage for the account times one minus the percentage shared by the merchant. For example, a five dollars insurance premium yield times a one percent insurance premium yield times (1-40% shared with the merchant) equals $0.03 in insurance premium portion profit. Information regarding an applicable insurance yield percentage for the account may be determined during the step 202.

Fourth, a promotional discount income amount for the credit card account during the designated time period may be determined. A promotional discount income amount for a credit card account is the percentage of the promotional sales made via the credit card account and paid to the credit card issuer or service provider by the merchant for offering special financing terms or other offers and may be calculated by multiplying the promotional sales amount times the negotiated promotional discount factor. For example, a promotional sale amount of $400 times a five percent discount factor is twenty dollars that will be paid by the merchant to the credit card issuer or service provider.

Fifth, a non-promotional discount income amount for the credit card account during the designated time period may be determined. A non-promotional discount income amount for the credit card account is the percentage of the sales amount paid to the card issuer or service provider for non-promotional sales (this percentage discount may be negative in which case the card service provider pays the merchant) made via the credit card account and may be determined by subtracting the net promotional sales for the designated time period from the net credit sales for the designated time period and multiplying the result times a discount percentage associated with the merchant. For example, $1,000 net credit sales minus $400 net promotional sales gives $600, which is multiplied by two percent and is twelve dollars. Thus, the merchant is paying two percent of all non-promotional sales to the credit card issuer or provider. Information regarding an applicable discount percentage for the account may be determined during the step 202.

Sixth, a cross-sell income amount for the credit card account during the designated time period may be determined. A cross-sell income amount for the credit card account is the income that the card service provider receives for cross sell transactions. In some embodiments, a cross-sell transaction may be or include an insert or other material placed in a statement a card service provider sends to an account holder, where the card service provider makes money on including the insert with the statement and/or on sales made as a result of the insert. In some embodiments, a cross-sell income amount may be determined by multiplying the net sales from cross-sell transactions times a margin percentage. For example, $20 in cross-sell transactions time a 0.5% margin is $0.10. Information regarding a margin percentage for the account may be determined during the step 202.

From the six previous determinations, a yield for the credit card account during the designated time period may be determined. For example, a yield for the credit card account may be determined by totaling the insurance premium portion amount, the promotional discount income amount, the non-promotional discount income amount, the cross-sell income amount, the amount of any finance charges received, the amount of any late charges received, the amount of any waived finance charges (which will be a negative value), and the amount of any waived late charges (which will be a negative value). For example, using the amounts computed above and $30 for a finance charge, $25 for a late charge, −$5 for a waived finance charge, and −$15 for a waived late charge, the yield for the credit card account for the designated time period is $67.13 (e.g., $67.13=$0.03+$20+$12+$0.10+$30+$25−$5−$15).

In addition to yield associated with the credit card account, an interest expense amount also may be associated with the credit card account. The interest expense amount may be associated with interest charges that the credit card issuer needs to pay with regards to current balance for the credit card account for purposing of extending credit for the credit card account. For example, $1,500 in outstanding balance times a 0.417% monthly interest expense equals $6.25.

Once the yield and the interest expense amount for the credit card account are determined, the contributed value amount of the credit card account during the designated time period can be determined as the difference between the yield and the interest expenses. For example, using the values for yield and interest expense amounts provided above, the contributed value amount of the credit card account during the designated time period is $60.75 (e.g., $60.75=$67−$6.25).

In some embodiments, a loss provision amount may be determined that is associated with the credit card account during the designated time period. The loss provision amount may be indicative of the portion of the outstanding balance that is at risk of not being paid and may be calculated by multiplying the current balance for the credit card account times a roll rate percentage. A roll rate percentage may be indicative of the actual or predicted loss rate determined for accounts with similar risk scores and delinquency status as the account under consideration and roll rate percentages may be assigned or determined empirically over time. For example, an account that is not past due and that has a low to moderate risk expectation, may have a loss provision of one percent (which may be adjusted for the observed recovery loss percentage for the portfolio over time). If the credit card account has a current balance of $1,500 and an applicable roll rate percentage of one percent, the loss provision amount for the credit card account is $15 (e.g., $15=$1,500×1%). Information regarding an applicable roll rate percentage for the account may be determined during the step 202.

In some embodiments, a gross loss amount may be determined that is associated with the credit card account during the designated time period. The gross loss amount may be indicative of an account with a bankruptcy status or an account balance that is not expected to be collected and may be calculated from a write off amount associated with the credit card account. For example, an account with a balance of $1,500 that is written-off will have $1,500 in the write-off amount field. Information regarding an applicable write off amount for the account may be determined during the step 202.

From the loss provision and gross loss amounts computed above, a net loss amount may be determined that is associated with the credit card account for the designated time period. The net loss amount may be indicative of either the loss provision or the write-off amount less the expected recovery loss percentage for the portfolio. For example, if the gross loss amount is greater than zero, then the net losses may be equal to the gross loss amount times (one minus a recovery loss percentage). The recovery loss percentage may be indicative of the expected or observed rate of dollars collected for every dollar written off in a portfolio. For example, if an average of $100,000 is written-off for a given portfolio in a month and $12,000 net is typically recovered on average, the recovery loss percentage is twelve percent. Information regarding an applicable recovery loss percentage may be determined during the step 202. If the gross loss amount is less than or equal to zero, then the net loss amount for the account may be equal to the loss provision amount. For example, if the account does not have a write-off amount, it is presumed not to be written-off and the loss provision amount is taken as the amount of (expected) net loss.

From the net loss amount and the contributed value amounts determined above, a risk adjusted contributed value may be determined which is equal to the contributed value amount minus the net loss amount. For example, using the values for the net loss amount and the contributed value amount provided above, the risk adjusted contributed value amount of the credit card account during the designated time period is $45.75 (e.g., $45.75=$60.75−$15).

In addition to income and losses, the credit card account may have one or more associated costs associated with it. For example, in some embodiments the account may have an acquisition cost associated with it, the acquisition cost representing the cost per account for a particular acquisition channel. An acquisition cost may represent the actual costs associated with acquiring the credit card account, may be set to a fixed amount, or may represent the average or allocated cost per credit card holder established by accounting or other procedures for a number of credit card accounts acquired or established during a pre-set or otherwise designated time period. For purposes of the present example, an acquisition cost of six dollars may be used for the credit card account. Information regarding the acquisition costs associated with one or more credit card accounts may be determined during the step 202.

As another example of a cost that may be associated with the credit card account, the account may have a customer relationship management (CRM) cost associated with it, the CRM cost representing the lifecycle expense associated with card service provider actions taken to maintain the relationship between the cardholder and card service provider. In some embodiments, a CRM cost may represent the actual costs associated with providing service to the holder of the credit card account, may be set to a fixed amount, or may represent the average or allocated CRM cost per credit card holder established by accounting or other procedures for a number of credit card accounts during a pre-set or otherwise designated time period. For purposes of the present example, a CRM cost of $0.17 per account per active month may be used for the credit card account. Information regarding the CRM costs associated with one or more credit card accounts may be determined during the step 202.

As another example of a cost that may be associated with the credit card account, the account may have a call center cost associated with it, the call center cost representing the expense of maintaining facilities to gather and answer cardholder inquiries. In some embodiments, a call center cost may represent the actual costs associated with providing call center service or support to the holder of the credit card account, may be set to a fixed amount, or may represent the average or allocated call center cost per credit card holder established by accounting or other procedures for a number of credit card accounts during a pre-set or otherwise designated time period. For purposes of the present example, a call center cost of $0.35 per account per active month may be used for the credit card account. Information regarding the call center costs associated with one or more credit card accounts may be determined during the step 202.

As another example of a cost that may be associated with the credit card account, the account may have a collection cost associated with it, the collection cost representing the expense of managing delinquent accounts. In some embodiments, a collection cost may represent the actual costs associated with collecting one or more overdue payments from the holder of the credit card account, may be set to a fixed amount, may vary depending on the number of payments due, or may represent the average or allocated collection cost per credit card holder established by accounting or other procedures for a number of credit card accounts during a pre-set or otherwise designated time period. For purposes of the present example, a collection cost of $2.75 per delinquent account per active month may be used for the credit card account. Information regarding the collection costs associated with one or more credit card accounts may be determined during the step 202.

As another example of a cost that may be associated with the credit card account, the account may have a manufacturing cost associated with it, the manufacturing cost representing the expenses associated with billing and payment processing. In some embodiments, a manufacturing cost may represent the actual costs associated with producing one or more statements or cards for an account during the designated time period, may be set to a fixed amount, may vary depending on the number of statements sent or cards issued, or may represent the average or allocated manufacturing cost per credit card holder established by accounting or other procedures for a number of credit card accounts during a pre-set or otherwise designated time period. For purposes of the present example, a manufacturing cost of $0.56 per account per active month may be used for the credit card account. Information regarding the manufacturing costs associated with one or more credit card accounts may be determined during the step 202.

As another example of a cost that may be associated with the credit card account, the account may have an enabling cost associated with it, the enabling cost representing over-head expenses to provide back-line support and analyses for the card service provider. In some embodiments, an enabling cost may represent the actual costs associated for an account during the designated time period, may be set to a fixed amount, or may represent the average or allocated enabling cost per credit card holder established by accounting or other procedures for a number of credit card accounts during a pre-set or otherwise designated time period. For purposes of the present example, an enabling cost of $0.92 (0.0616% times the average outstanding balance ($1,500) per active account per month) may be used for the credit card account. The 0.0616% number may be determined empirically over a time period (e.g., twelve months). Information regarding the enabling costs associated with one or more credit card accounts may be determined during the step 202.

Once all of the individual costs are determined for the credit card account for the designated time period, they may be summed to create a total cost associated with the credit card account during the designated time period. For example, for the costs described above, the total cost for the credit card account for the designated time period is $10.75 (e.g., $10.75=$6+$0.17+$0.35+$2.75+$0.56+$0.92).

Once the total risk adjusted contributed value and the total costs for the credit card account are determined, a gross income for the credit card account for the designated time period can then be determined by subtracting the total costs from the risk adjusted contributed value (e.g., $35=$45.75−$10.75).

Taxes for the gross income can then be calculated using tax tables or a tax rate can be assumed. For purposes of the present example, a tax rate of forty percent will be assumed. Information regarding the applicable tax rate may be determined during the step 202. Thus, the tax amount is fourteen dollars (e.g., $14=$35×(0.40)). Net income equals gross income minus the tax amount (e.g., $21=$35−$14). The net income for the credit card account is a score in dollars that is indicative of the profitability of the credit card account.

In some embodiments, the risk adjusted contributed value and the total costs for a given designated period (e.g., one month) may be used to determine profitability over a greater period of time (e.g., twelve months). For example, each risk adjusted contributed value amount for a credit card account may be calculated for each month in a twelve month period. The risk adjusted contributed value for the twelve month period credit card account may be the sum of the twelve individual contributed value amounts less the loss provision for only the final month (contributed values are additive, however, loss provisions are not additive). Similarly, the total cost associated with the credit card account for the twelve month period may be each to the sums of the costs associated with the credit card account for each of the twelve individual months. The total net income associated with the account for the twelve-month period may be the total gross income for the twelve month period minus amounts allocated to taxes.

If the sum of outstanding balances for the credit card over the greater period of time (e.g., twelve months of activity) is greater than zero, then an average net investment for the credit card account can be determined by dividing such sum of outstanding monthly balances by twelve active months. For example, $18,000 total outstanding balance for twelve months (e.g., the sum of each month's balance for twelve consecutive months) divided by twelve months of balance activity results in an average net investment of $1,500.

Once the net income for the designated period (e.g., one month) is determined for the credit card account (e.g., $21 in this example), an annualized return on investment for the credit card account may be determined by summing the net income over a twelve month period and dividing by average net investment for the same twelve month period. For example, assuming $21 net income per month for twelve months for simplicity, $21 times twelve is $252 in total net income for twelve months and $252 divided by $1,500 average net investment is 16.8%. The annualized return on investment for the credit card account is a score in percent that is indicative of the profitability of the credit card account.

During a step 206, a course of action regarding or related to the account is determined based, at least in part, on the score determined during the step 204. For example, based on the score(s) associated with one or more credit card accounts, a credit card issuer, merchant, or other party may do one or more of the following: segment or categorize the credit card accounts with a segment of a plurality of accounts based on the profitability scores associated with the credit card accounts; offer a discount, promotion, or other benefit to a person associated with a credit card account, wherein the benefit or the selection of the person is based on the score; waive, reduce, increase, or add a fee associated with a credit card account based on the score; associating a credit card account with one of a plurality of account categories based on the score; selecting a communication to be sent to a person associated with a credit card account, wherein the person and/or the communication are selected based on the profitability score associated with the credit card account; select a level of customer service to be provided to a user of a credit card account based on the profitability score associated with the credit card account; authorize a transaction using a credit card account based on the profitability score associated with the credit card account; deny authorization for a transaction using a credit card account based on the profitability score associated with the credit card account; terminate a credit card account based on the profitability score associated with the credit card account; renew a credit card account based on the profitability score associated with the credit card account; etc.

As another example of the step 206, in some embodiments, determining a course of action regarding one or more credit card accounts may be or include modifying one or more terms associated with one or more of the credit card accounts based on one or more profitability scores. For example, if a credit card account is not profitable, the interest rate or finance charge associated with the credit card account may be increased; the maximum credit limit or balance allowed with the credit card account may be decreased; the minimum monthly payment or payment percentage for the account may be increased; etc.

In some embodiments, the method 200 may include determining a person associated with a credit card account, determining a credit card account to evaluate, communicating with a person associated with a credit card account (e.g., to verify or request information), etc.

In some embodiments, the step 206 may be optional and not used in the method 200. Rather, the method may include a step in which data indicative of the score determined during the step 204 is provided to another party, entity, device, software application, etc. For example, after a profitability for one or more credit card accounts is determined, the profitability information may be provided in a communication (e.g., email message, instant message communication, facsimile transmission, voicemail message, FTP or XML transmission, etc.) to one or more designated parties, software applications, devices, databases, etc.

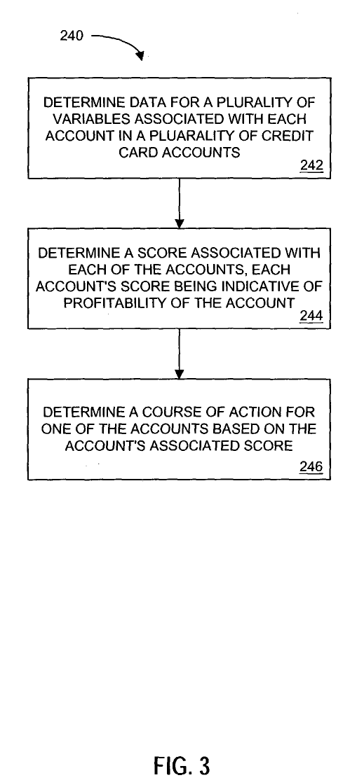

Reference is now made to FIG. 3, where a flow chart 240 is shown which represents the operation of a second embodiment of the present invention. The particular arrangement of elements in the flow chart 240 is not meant to imply a fixed order to the steps; embodiments of the present invention can be practiced in any order that is practicable. In some embodiments, some or all of the steps of the method 240 may be performed or completed by the server 102 and/or another device. In some embodiments, the method 240 may include some or all of the variations discussed above in regards to the method 200.

Processing begins at a step 242 during which data for a plurality of variables is determined for each account in a plurality of credit card accounts. The step 242 is similar to the step 202 previously discussed above.

During a step 244, a score is determined for each of the accounts, wherein the score associated with an account is indicative of the account's profitability. The step 244 is similar to the step 204 previously discussed above.

During a step 246, a course of action regarding or related to one or more of the plurality of accounts determined based, at least in part, on one or more of the scores determined during the step 244. The step 246 is similarly to the step 206 previously discussed above.

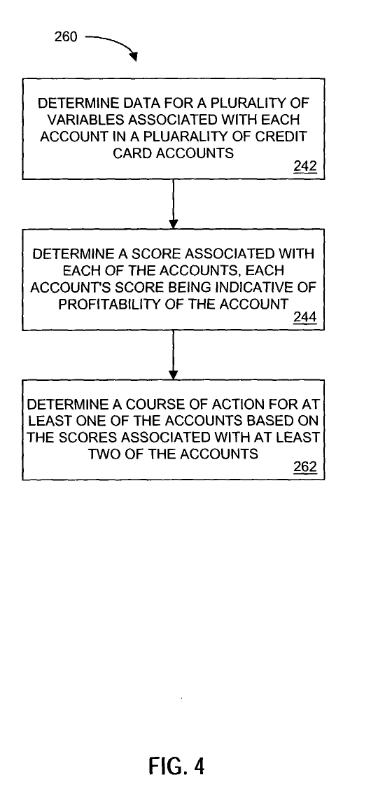

Reference is now made to FIG. 4, where a flow chart 260 is shown which represents the operation of a third embodiment of the present invention. The particular arrangement of elements in the flow chart 260 is not meant to imply a fixed order to the steps; embodiments of the present invention can be practiced in any order that is practicable. In some embodiments, some or all of the steps of the method 260 may be performed or completed by the server 102 and/or another device. In some embodiments, the method 260 may include some or all of the variations discussed above in regards to the method 200.

The method 260 includes the steps 242 and 244 previously discussed above. In addition, the method 262 includes a step 262 during which a course of action regarding or related to one or more of the plurality of accounts determined based, at least in part, on one or more of the scores determined during the step 244. In some embodiments, the step 262 may include determining a course of action applicable to all of the accounts based on one or more of the scores determined during the step 244. The step 262 is similar to the step 206 previously discussed above. For example, based on the score(s) associated with one or more credit card accounts, a credit card issuer, merchant, or other party may do one or more of the following: offer a benefit to each person associated with a credit card account in a plurality of credit card accounts; select a communication to be sent to each person associated with a credit card account in a plurality of credit card accounts; select a level of customer service to be provided to a person associated with a credit card account in a plurality of credit card accounts; terminate a plurality of credit card accounts; change a term associated with each credit card account in a plurality of credit card accounts; etc.

Server

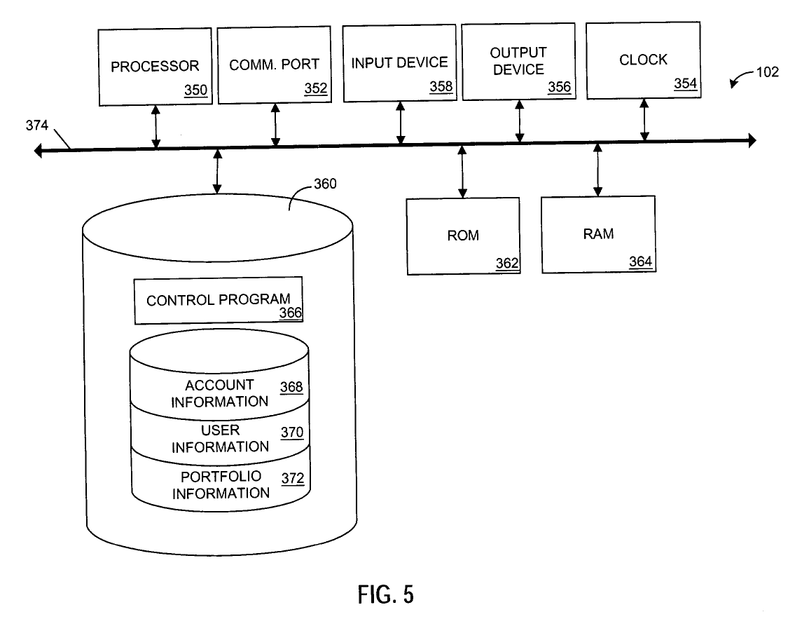

Now referring to FIG. 5, a representative block diagram of the server or controller 102 is illustrated. The server 102 may include a processor, microchip, central processing unit, or computer 350 that is in communication with or otherwise uses or includes one or more communication ports 352 for communicating with user devices and/or other devices. Communication ports may include such things as local area network adapters, wireless communication devices, Bluetooth technology, etc. The server 102 also may include an internal clock element 354 to maintain an accurate time and date for the server 102, create time stamps for communications received or sent by the server 102, etc. In some embodiments, the server 102 may comprise or include a mainframe computer or computer system or other type of computer or computer system.

If desired, the server 102 may include one or more output devices 356 such as a printer, infrared or other transmitter, antenna, audio speaker, display screen or monitor, text to speech converter, etc., as well as one or more input devices 358 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 102 may include a memory or data storage device 360 to store information, software, databases, communications, device drivers, algorithms, variables, etc. The memory or data storage device 360 may comprise an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 102 also may include separate ROM 362 and RAM 364.

The processor 350 and the data storage device 360 in the server 102 each may be, for example: (i) located entirely within a single computer or other computing device; or (ii) connected to each other by a remote communication medium, such as a serial port cable, telephone line or radio frequency transceiver. In one embodiment, the server 102 may comprise one or more computers that are connected to a remote server computer for maintaining databases.

A conventional personal computer, mainframe, or workstation with sufficient memory and processing capability may be used as the server 102. In one embodiment, the server 102 operates as or includes a Web server for an Internet environment. The server 102 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 350. Other or equivalent processors are available from Motorola, Inc., AMD, or Sun Microsystems, Inc. The processor 350 also may comprise one or more microprocessors, computers, computer systems, etc.

Software may be resident and operating or operational on the server 102. The software may be stored on the data storage device 360 and may include a control program 366 for operating the server, databases, etc. The control program 366 may control the processor 350. The processor 350 preferably performs instructions of the control program 366, and thereby operates in accordance with the present invention, and particularly in accordance with the methods described in detail herein. The control program 366 may be stored in a compressed, uncompiled and/or encrypted format. The control program 366 furthermore includes program elements that may be necessary, such as an operating system, a database management system and device drivers for allowing the processor 350 to interface with peripheral devices, databases, etc. Appropriate program elements are known to those skilled in the art, and need not be described in detail herein.

The server 102 also may include or store information regarding users, user devices, credit card accounts, merchants, accounts or portfolios, evaluation variables and formulas, account related decisions, account or portfolio profitabilities, communications, etc. For example, information regarding one or more accounts may be stored in an account information database 368 for use by the server 102 or another device or entity. Information regarding one or more users may be stored in a user information database 370 for use by the server 102 or another device or entity and information regarding one or more portfolios of credit card accounts may be stored in a portfolio information database 372 for use by the server 102 or another device or entity. In some embodiments, some or all of one or more of the databases may be stored or mirrored remotely from the server 102.

According to an embodiment of the present invention, the instructions of the control program may be read into a main memory from another computer-readable medium, such as from the ROM 362 to the RAM 364. Execution of sequences of the instructions in the control program causes the processor 350 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 350, communication port 352, clock 354, output device 356, input device 358, data storage device 360, ROM 362, and RAM 364 may communicate or be connected directly or indirectly in a variety of ways. For example, the processor 350, communication port 352, clock 354, output device 356, input device 358, data storage device 360, ROM 362, and RAM 364 may be connected via a bus 374.

While specific implementations and hardware configurations for servers 102 have been illustrated, it should be noted that other implementations and hardware configurations are possible and that no specific implementation or hardware configuration is needed. Thus, not all of the components illustrated in FIG. 5 may be needed for a server implementing the methods disclosed herein.

User Device

As mentioned above, the user device 106 may be or include any of a number of different types of devices, including, but not limited to a personal computer, portable computer, mobile or fixed user station, workstation, network terminal or server, telephone, beeper, kiosk, mainframe terminal, personal digital assistant, facsimile machine, two-way pager, radio, cable set-top box, etc. In some embodiments, the user device 106 may have the same structure or configuration as the server 102 illustrated in FIG. 5 and include some or all of the components of the server 102.

Databases

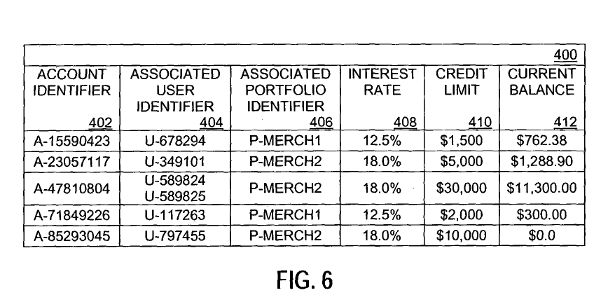

As previously discussed above, in some embodiments a server, user device, or other device may include or access an account information database for storing or keeping information regarding one or more credit card accounts. In some embodiments, the credit card accounts may be consumer and/or commercial accounts. One representative account information database 400 is illustrated in FIG. 6.

The account information database 400 may include an account identifier field 402 that may include codes or other identifiers for one or more credit card accounts, an associated user identifier field 404 that may includes codes or other identifiers for one or more users associated with the accounts identified in the field 402, an associated portfolio identifier field 406 that may include codes or other identifiers of portfolios associated with the accounts identified in the field 402, an interest rate field 408 that may include information regarding the interests associated with the accounts identified in the field 402, a credit limit field 410 that may include information regarding the credit limits associated with the accounts identified in the field 402, and a current balance field 412 that may include information regarding the current balances for the accounts identified in the field 402.

Other or different fields also may be used in the account information database 400. For example, in some embodiments an account information database may include information regarding payment history, past delinquencies, transaction history, account establishment date, acquisition costs, CRM costs, communication costs, call center use and costs, enabling costs, manufacturing costs, collection costs, finance charges, late fees, profitability history or scores, etc. associated with one or more credit card accounts.

As illustrated by the account information database 400 of FIG. 6, the account identified as “A-15590423” in the field 402 is associated with the user identified as “U678924” and the portfolio identified as “P-MERCH1”. The account “A-15590423” has an interest rate of “12.5%”, a credit limit of “$1,500”, and a current balance of “$762.38”. In some embodiments, an account may have more than one associated user.

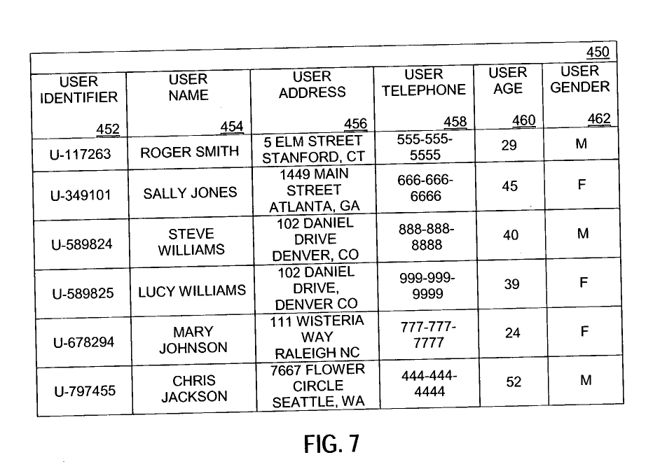

As previously discussed above, in some embodiments a server, user device, or other device may include or access a user information database for storing or keeping information regarding one or more users associated with credit card accounts. One representative user information database 450 is illustrated in FIG. 7.

The user information database 400 may include a user identifier field 452 that may include codes or other identifiers for one or more users associated with credit card accounts, a user name field 454 that may include names or other descriptive information of the users identified in the field 452, a user address field 456 that may include address and other contact information for the users identified in the field 452, a user telephone field 458 that may include telephone number information for the users identified in the field 452, a user age field 460 that may include age information for the users identified in the field 452, and a user gender field 462 that may include gender information for the users identified in the field 452.

Other or different fields also may be used in the user information database 450. For example, in some embodiments a user information database may include information regarding the marital status, family status, occupation, income, citizenship, employment history, credit rating, transaction history, email address, residence history, educational background, hobbies or preferences, etc. of one or more users.

As illustrated by the user information database 450 of FIG. 7, the user identified as “U-678294” in the field 452 is named “MARY JOHNSON”, is female, and is twenty-four years older. The user “MARY JOHNSON” can be reached at the address and telephone number provided.

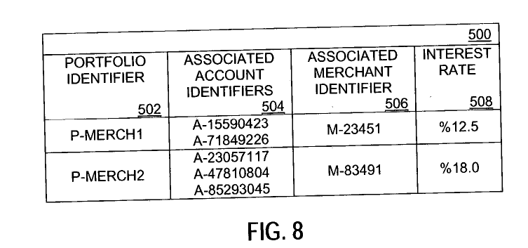

As previously discussed above, in some embodiments a server, user device, or other device may include or access a portfolio information database for storing or keeping information regarding one or more portfolios of credit card accounts. In some embodiments, the credit card accounts may be consumer and/or commercial accounts. One representative portfolio information database 500 is illustrated in FIG. 8.

The portfolio information database 500 may include a portfolio identifier field 502 that may include codes or other identifiers for one or more portfolios of credit card accounts, an associated account identifier field 504 that may include codes or other identifiers for one or more credit card accounts associated with the portfolios identified in the field 502, an associated merchant identifier field 506 that may include codes or other identifiers for merchants, credit card issuers, or other providers associated with the portfolios identified in the field 502, and an interest rate field 508 that may include information regarding interest rates associated with the portfolios identified in the field 502.

Other or different fields also may be used in the portfolio information database 500. For example, in some embodiments a user information database may include information regarding the date portfolios were established, modified or terminated, the dates one or more accounts were added to or removed from a portfolio, individual or average profitability information or scores for accounts associated with portfolios, requirements, contractual obligations, or limitations in place for accounts associated with different portfolios, etc.

As illustrated by the portfolio information database 500 in FIG. 8, the portfolio identified as “P-MERCH2” has three associated credit card accounts, namely “A23057117”, “A-47810804”, and “A-85293045”. The portfolio “P-MERCH2” is associated with merchant identifier M-83491 and has an interest rate of “18.0%”. Each of the credit card accounts included in the portfolio “P-MERCH2” may be provided as a private label credit card by the merchant identified as “M-83491” or may otherwise be associated with the merchant identified as “M-83491”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for using making use of a profitability of a credit card account, comprising:
determining data for a plurality of variables associated with a credit card account;
determining a score associated with said account based, at least in part, on said data for a plurality of variables, wherein said score is indicative of a profitability of said credit card account; and
determining a course of action regarding said credit card account based, at least in part, on said score.

2. The method of claim 1, wherein said determining data for a plurality of variables associated with a credit card account includes receiving data regarding at leastone cost associated with the credit card account.

3. The method of claim 1, wherein said determining a score associated with said account based, at least in part, on said data for a plurality of variables, wherein said score is indicative of a profitability of said account includes:
determining a net income amount for said credit card account during a designated time period; and
determining an average net investment amount for the credit card account for said time period.

4. The method of claim 1, wherein said determining a course of action regarding said credit card account based, at least in part, on said score includes associating said account with a segment of a plurality of accounts, each of which have a score that falls within a designated range.

5. The method of claim 1, wherein said determining a course of action regarding said credit card account based, at least in part, on said score includes offering a benefit to a user associated with said account, wherein said benefit is based on said score.

6. The method of claim 1, wherein said determining a course of action regarding said credit card account based, at least in part, on said score includes at least one of the following:
terminating said account based on said score;
charging an additional fee to said account based on said score;
waiving a fee associated with said account based on said score;
renewing said account based on said score; and
changing a fee charged to said account based on said score.

7. The method of claim 1, wherein said determining a course of action regarding said credit card account based, at least in part, on said score includes selecting a communication to be sent to said account based, at least in part, on said score.

8. The method of claim 1, wherein said determining a course of action regarding said credit card account based, at least in part, on said score includes selecting a level of customer service to be provided to a user of said account based on said score;

9. The method of claim 1, wherein said determining a course of action regarding said credit card account based, at least in part, on said score includes authorizing a transaction using said account based on said score.

10. The method of claim 1, wherein said determining a course of action regarding said credit card account based, at least in part, on said score includes modifying at least one term associated with said account based on said score.

11. The method of claim 1, wherein said credit card account is included in a portfolio of credit card accounts.

12. The method of claim 11, further comprising:
determining a course of action for said portfolio of credit card accounts based, at least in part, on said score.

13. The method of claim 12, further comprising:
determining data for a plurality of variables associated with each of said accounts in said portfolio; and
determining a score associated with each of said accounts in said portfolio, wherein a score associated with an account is indicative of a profitability of said account.

14. The method of claim 1, further comprising:
determining said credit card account.

15. The method of claim 1, further comprising:
determining a user associated with said credit card account.

16. A method for making a determination regarding a credit card account, comprising:
determining data for a plurality of variables associated with each account in a plurality of credit card accounts;
determining a score associated with each account in said plurality of credit card accounts based, at least in part, on said data for a plurality of variables associated with said account, wherein a score for an account is indicative of a profitability of said account; and
determining a course of action for an account in said plurality of credit card accounts based, at least in part, on said account's associated score.

17. A method for making a determination regarding at least one credit card account, comprising:
determining a plurality of credit card accounts;
determining data for a plurality of variables associated with each credit card account in said plurality of credit card accounts;
determining a score associated with each credit card account in said plurality of credit card accounts based, at least in part, on said data for a plurality of variables associated with said account, wherein a score for a credit card account is indicative of a profitability of said credit card account; and
determining a course of action for at least one of said accounts in said plurality of credit card accounts based, at least in part, on at least two scores associated with credit card accounts in said plurality of credit card accounts.

18. The method of claim 17, wherein said determining a course of action for at least one of said accounts based, at least in part on at least two scores associated with accounts in said plurality of credit card accounts includes determining a course of action for said plurality of credit card accounts.

19. The method of claim 18, wherein said determining a course of action for said plurality of accounts includes at least one of the following:
offering a benefit to each user associated with an account in said plurality of credit card accounts;
selecting a communication to be sent to each user associated with an account in said plurality of credit card accounts;
select a level of customer service to be provided to a user of an account in said plurality of credit card accounts;
terminating said plurality of credit card accounts; and
changing a term associated with account in said plurality of credit card accounts.

20. The method of claim 18, further comprising:
identifying the most profitable accounts in said plurality of accounts.

21. A method for determining profitability of a credit card account in a portfolio of credit card accounts, comprising:
selecting a credit card account from a portfolio of credit card accounts;
determining a gross income associated with said credit card account for a designated time period;
determining an average net investment associated with said credit card account for said designated time period; and
determining a score for said credit card account based on said gross income and said net investment, said score being indicative of profitability for said credit card account.

22. The method of claim 21, wherein said determining a net investment associated with said credit card account for a designated time period includes determining a sum of balances for said credit card account for a designated number of months and dividing by the designated number of months.

23. The method of claim 21, wherein said determining a gross income associated with said credit card account for a designated time period includes determining at least one of the following:
an insurance premium portion amount associated with said credit card account;
a promotional discount income amount associated with said credit card account;
a non-promotional discount income amount associated with said credit card account; and
a cross-sell income amount associated with said credit card account.

24. The method of claim 23, wherein said determining a gross income associated with said credit card account for a designated time period includes determining at least one of the following:
a finance charge received amount associated with said credit card account;
a waived finance charge amount associated with said credit card account;
a late charge received amount associated with said credit card account; and
a waived late charge amount associated with said credit card account.

25. The method of claim 21, wherein said determining a gross income associated with said credit card account for a designated time period includes determining an insurance premium portion amount associated with said credit card account; a promotional discount income amount associated with said credit card account; a non-promotional discount income amount associated with said credit card account; a cross-sell income amount associated with said credit card account; a finance charge received amount associated with said credit card account; a waived finance charge amount associated with said credit card account; a late charge received amount associated with said credit card account; and a waived late charge amount associated with said credit card account.

26. The method of claim 26, wherein said determining an average net investment associated with said credit card account for said designated time period includes determining an enabling cost associated with said credit card account, a manufacturing cost associated with said credit card account, a collection cost associated with said credit card account, a call center cost associated with said credit card account, a customer relationship management cost associated with said credit card account, and an acquisition cost associated with said credit card account.

27. The method of claim 21, wherein said determining an average net investment associated with said credit card account for said designated time period includes determining at least one of the following:
an enabling cost associated with said credit card account;
a manufacturing cost associated with said credit card account;
a collection cost associated with said credit card account;
a call center cost associated with said credit card account;
a customer relationship management cost associated with said credit card account;
and an acquisition cost associated with said credit card account.

28. A system for making a determination regarding a credit card account, comprising:
a memory;
a communication port; and
a processor connected to said memory and said communication port, said processor being operative to:
determine data for a plurality of variables associated with a credit card account;
determine a score associated with the account based, at least in part, on the data for a plurality of variables, wherein the score is indicative of a profitability of the credit card account; and
determine a course of action regarding the credit card account based, at least in part, on the score.

29. A computer program product in a computer readable medium for making a determination regarding a credit card account, comprising:
first instructions for obtaining data for a plurality of variables associated with a credit card account;
second instructions for calculating a score associated with the account based, at least in part, on the data for a plurality of variables, wherein the score is indicative of a profitability of the credit card account; and
third instructions for identifying a course of action regarding the credit card account based, at least in part, on the score.

30. A system for determining profitability of a credit card account, comprising:
a memory;
a communication port; and
a processor connected to said memory and said communication port, said processor being operative to:
select a credit card account from a portfolio of credit card accounts;
determine a gross income associated with said credit card account for a designated time period;
determine an average net investment associated with said credit card account for said designated time period; and
determine a score for said credit card account based on said gross income and said net investment, said score being indicative of profitability for said credit card account.

31. A computer program product in a computer readable medium for determining profitability of a credit card account, comprising:
first instructions for identifying a credit card account from a portfolio of credit card accounts;
second instructions for identifying a gross income associated with said credit card account for a designated time period;
third instructions for identifying an average net investment associated with said credit card account for said designated time period; and
fourth instructions for calculating a score for said credit card account based on said gross income and said net investment, said score being indicative of profitability for said credit card account.
